(19) United States
(12) Patent Application Publication
(10) Pub. No.: US 2024/0342849 A1
(43) Pub. Date: Oct. 17, 2024

(54) AUTOMATIC FEEDING, GRINDING, AND SORTING OF WOODWORKING KNIVES

(71) Applicant: Simonds International L.L.C., Woodland, WA (US)

(72) Inventors: Gary Arthur Stroud, West Kelowna (CA); Vincent Bergeron, Prince George (CA); Nathaniel Bergeron, Prince George (CA)

(21) Appl. No.: 18/636,037

(22) Filed: Apr. 15, 2024

Related U.S. Application Data
(60) Provisional application No. 63/495,875, filed on Apr. 13, 2023.

(51) Int. Cl. B24B 3/38; B24B 51/00

(52) U.S. Cl. CPC B24B 3/38; B24B 51/00

(57) ABSTRACT

An apparatus for feeding, grinding, and sorting a woodworking knife may include a guide track system with a lugged endless loop for moving woodworking knives along a flow path through a grinding assembly, and optionally to a rotary sorting station. Corresponding systems and methods for feeding, grinding, and sorting a woodworking knife are also disclosed herein.

### TECHNICAL FIELD

The present disclosure generally relates to a machine for woodworking knife maintenance and/or production, and, more specifically, to an automatic machine designed for feeding, grinding, and sorting woodworking knives.

### BACKGROUND

Industrial woodworking knives, such as for example Key Knife™ chipping knives, are essential components of industrial woodworking machinery (e.g., chippers, planers, etc.) and require periodic sharpening and maintenance to ensure optimal performance. Manual processes for feeding, grinding, and sorting woodworking knives can be time-consuming, labor-intensive, and prone to human error. An automated solution is desired to improve efficiency, accuracy, and safety in woodworking knife production and maintenance processes.

A need therefore exists for an automatic machine designed for feeding, grinding, and sorting woodworking knives that exhibits improved efficiency, accuracy, and safety over existing manual processes.

### SUMMARY

The present disclosure provides embodiments of an automatic machine for feeding, grinding, and sorting woodworking knives, control systems for such machines, and methods for feeding, grinding, and sorting woodworking knives. The present disclosure addresses deficiencies in existing woodworking knife maintenance machines and methods, and provides an improved machine for woodworking knife maintenance/production.

An advantage of the present disclosure is the provision of machines for woodworking knife maintenance and components thereof (e.g. hoppers, guide track systems, grinding assemblies, etc.) having improved characteristics over existing technologies, tools, processes, and systems.

In some embodiments, a machine for feeding, grinding, and sorting a woodworking knife includes: a hopper for releasably retaining a woodworking knife and having a receiving end and a feeding end, the hopper being gravity fed; a grinding assembly, the grinding assembly having a first grinding wheel and a second grinding wheel; a guide track system for receiving the woodworking knife at a first end and releasing the woodworking knife at a second end, the guide track system comprising a chain with lugs for releasably retaining the woodworking knife and an actuator for moving the woodworking knife received onto the chain with lugs from the first end and the second end, wherein the first end faces the feeding end of the hopper and the second end is positioned distal the feeding end of the hopper, and the guide track system is positioned such that both the first and second grinding wheels are capable of concurrently contacting the woodworking knife as it is moved from the first end to the second end; when the received woodworking knife is moved to the second end of the guide track system, it is released from the chain with lugs; a rotary sorting station, the rotary sorting station positioned to receive and sort the woodworking knife after it is released from the second end of the guide track system; and one or more measurement probes positioned and aligned to take a measurement of the woodworking knife as the woodworking knife is moved along the guide track system between the hopper and the grinding assembly; and a programmable logic controller (PLC).

In an embodiment of the automatic machine herein, the chain with lugs receives a woodworking knife from the hopper by pulling the woodworking knife as it drops into the guide track system.

In an embodiment of the automatic machine herein, the measurement of the woodworking knife by the one or more measurement probes comprises measuring the dimensions of the edge of the woodworking knife.

In an embodiment of the automatic machine herein, the PLC determines the woodworking knife's grind status based on the results of the measurement of the one or more measurement probes.

In an embodiment of the automatic machine herein, the woodworking knife's grind status comprises a first grind, a second grind, a third grind, or scrap.

In an embodiment of the automatic machine herein, one or both of the first and second grinding wheels adjust their height based on the PLC's determination of the woodworking knife's grind status.

In an embodiment of the automatic machine herein, one or both of the first and second grinding wheels adjust their height based on the PLC's determination of a third grind such that the measured and determined woodworking knife does not contact the first and second grinding wheels.

In an embodiment of the automatic machine herein, the rotary sorting station comprises one or more buckets mounted on a rotary bearing, the rotary sorting station rotates to align one of the one or more buckets with the second end of the guide track system, such that the aligned bucket receives a woodworking knife released from the guide track system.

In an embodiment of the automatic machine herein, the one or more buckets are rotatably positioned, such that a designated bucket receives a woodworking knife based on the woodworking knife's grind status.

In an embodiment, the present disclosure relates to a method for automatically feeding, grinding, and sorting woodworking knives, the method comprising: (a) providing a plurality of woodworking knives to through a receiving end of a hopper; (b) gravity-feeding the woodworking knives through the feeding end of a hopper onto a first end of a guide track system; (c) pulling knives through the guide track system using a chain with lugs; (d) measuring the woodworking knife's grind status using one or more measurement probes; (e) determining the woodworking knife's grind status with a programmable logic controller (PLC); (f) adjusting the height of one or both of a first grinding wheel and a second grinding wheel of a grinding assembly based on the PLC's determination of the woodworking knife's grind status; (g) moving the woodworking knife through the grinding assembly to a second end of the guide track system, thereby grinding the woodworking knife; and (h) receiving the woodworking knife into a designated bucket of a rotary sorting station, thereby sorting the ground woodworking knife.

In an embodiment of the methods herein, the steps of determining the woodworking knife's grind status, adjusting the height of the first and second grinding wheels, and sorting the woodworking knife enable efficient maintenance of the woodworking knife based on the woodworking knife's grind status.

Other aspects and embodiments of the disclosure are evident in view of the detailed description provided herein.

### BRIEF DESCRIPTON OF THE DRAWINGS

Further advantages, permutations and combinations of the invention will now appear from the above and from the following detailed description of the various particular embodiments of the invention taken together with the accompanying drawings, each of which are intended to be non limiting, in which:

FIGS. 1A and 1B are perspective views of an automatic knife grinder system for feeding, grinding, and sorting industrial woodworking knives;

FIGS. 1C and 1D are front and rear elevational views, respectively, of the system of FIGS. 1A and 1B;

FIGS. 1E and 1F are elevational views of the infeed end and the outfeed end, respectively, of the system of FIGS. 1A and 1B;

FIG. 1G is a plan view of the system of FIGS. 1A and 1B;

FIG. 1H is a perspective view of components of the system of FIGS. 1A and 1B;

FIG. 2 is a perspective view of the frame;

FIGS. 3A, 3B, and 3C are perspective, end elevational, and plan views, respectively, of the guide track assembly with some components removed for clarity;

FIGS. 3D, 3E, and 3F are side elevational, end elevational, and perspective views of a portion of the endless loop;

FIG. 4 is a perspective view of a hopper, a measuring assembly, and a track assembly shown relative to portions of the frame;

FIGS. 5A and 5B are perspective views of the hopper;

FIGS. 5C and 5D are front and side elevational views, respectively, of the hopper of FIGS. 5A and 5B;

FIGS. 6A, 6B, and 6C are front elevational, perspective, and side elevational views, respectively, of a hold-down assembly;

FIG. 7A is a plan view of a sensor assembly in combination with the track assembly, hopper, and hold-down assembly;

FIG. 7B is a perspective view of a pair of sensors suitable for use in the sensor assembly of FIG. 7A;

FIG. 8 is a perspective view of the sensor assembly of FIG. 7A, with some components removed for clarity;

FIGS. 9A and 9B are end elevational views of the sensor assembly before and during a knife measurement, with some components removed for clarity;

FIG. 10 is an end elevational view of the grinder assembly relative to portions of the frame as viewed from a downstream end of the track;

FIG. 11 is a partially exploded perspective view of a grinder assembly and components thereof;

FIG. 12 shows the grinding wheels relative to a knife on the guide track assembly as viewed from a downstream end of the track;

FIGS. 13A and 13B are perspective views of the sorter assembly, with some components removed for clarity in FIG. 13B;

FIGS. 13C and 13D are a plan view and a partial perspective view of the sorter assembly and components thereof;

FIG. 14 illustrates a computer-implemented method of operating a knife grinder apparatus;

FIG. 15 illustrates additional details of the method of FIG. 14;

FIG. 16 illustrates a controller configured to implement various operations described herein;

FIG. 17 illustrates a user interface configured to implement various operations described herein; and

FIGS. 18A-18H illustrate an example of a graphical user interface (GUI); all in accordance with embodiments of the present disclosure.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

The embodiments of the present disclosure pertain to automatic machines for feeding, grinding, and sorting woodworking knives, grinding assemblies, guide track systems, rotary sorting stations and methods having improved functionality for maintaining woodworking knives. In the illustrated embodiment, the woodworking knives are Key Knife™ chipping knives.

The present disclosure provides a number of advantages over existing technologies. For example, existing machines for feeding, grinding, and sorting woodworking knives are not accurate enough to maintain woodworking knives to desired or even acceptable tolerances. This is due to a number of factors, including for example human error. Moreover, existing machines for feeding, grinding, and sorting woodworking require manual operation and are inefficient.

An advantage of the present disclosure is the provision of machines for feeding, grinding, and sorting woodworking techniques having improved characteristics over existing technologies, in particular using automatic operation.

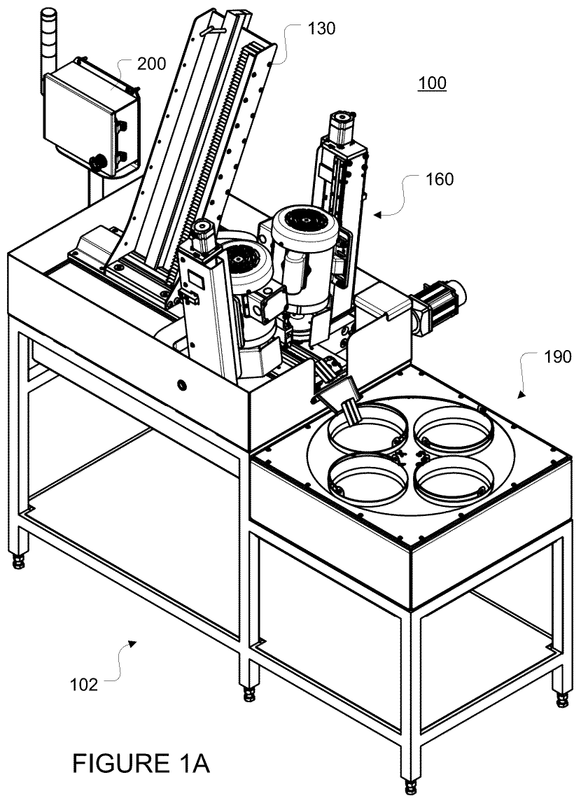

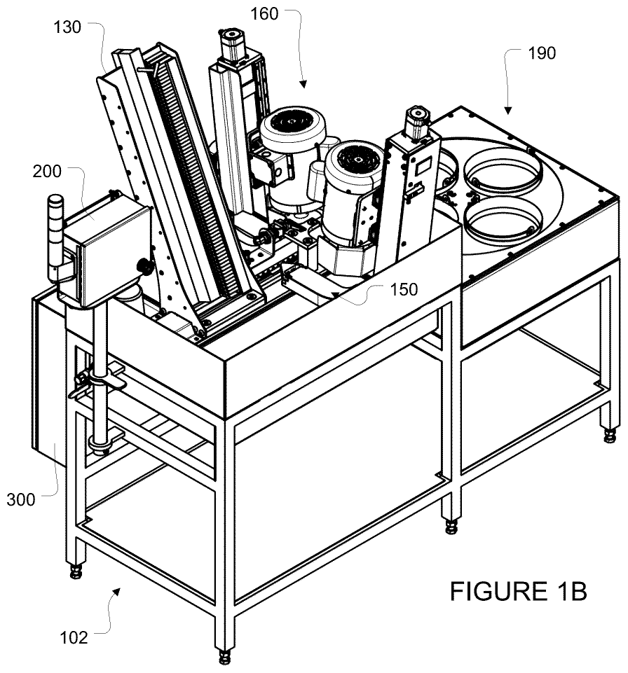

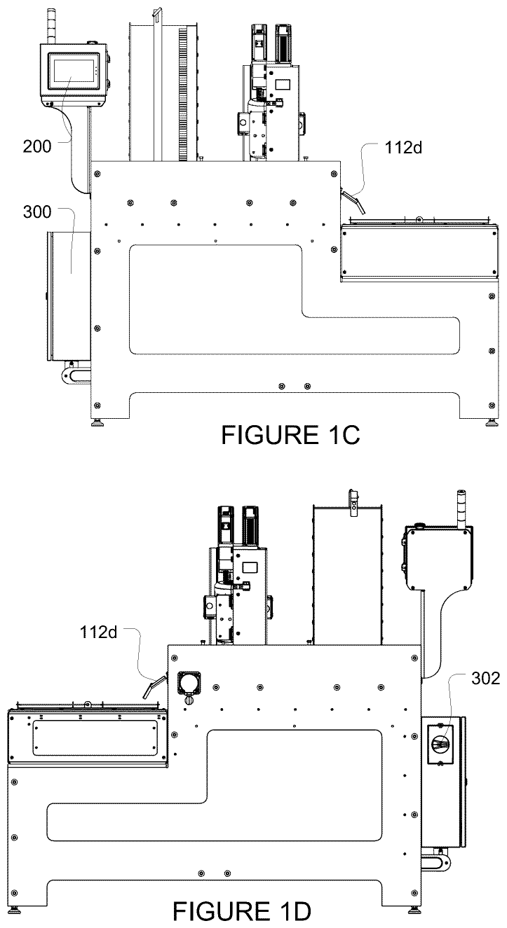

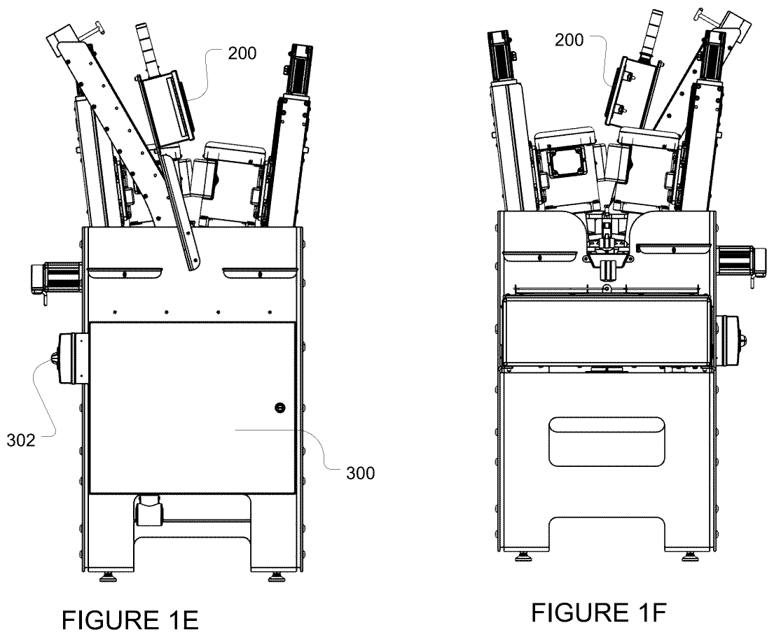

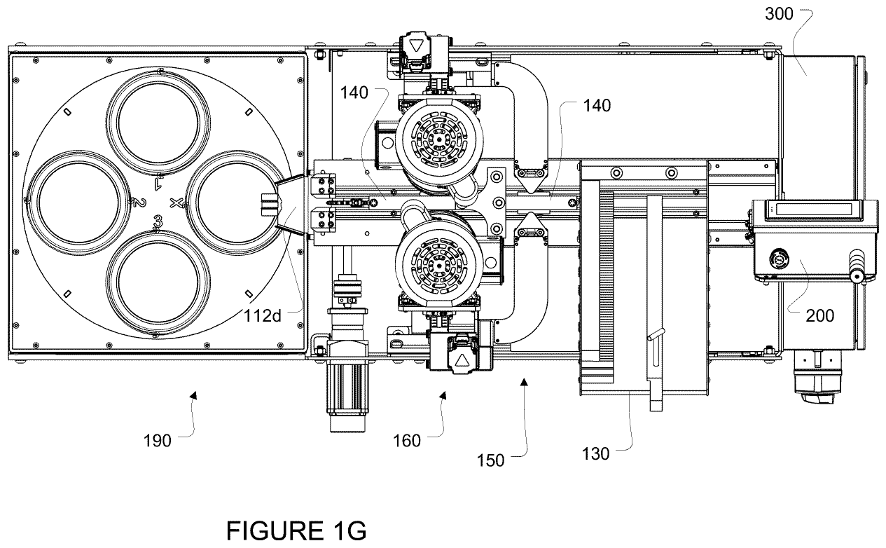

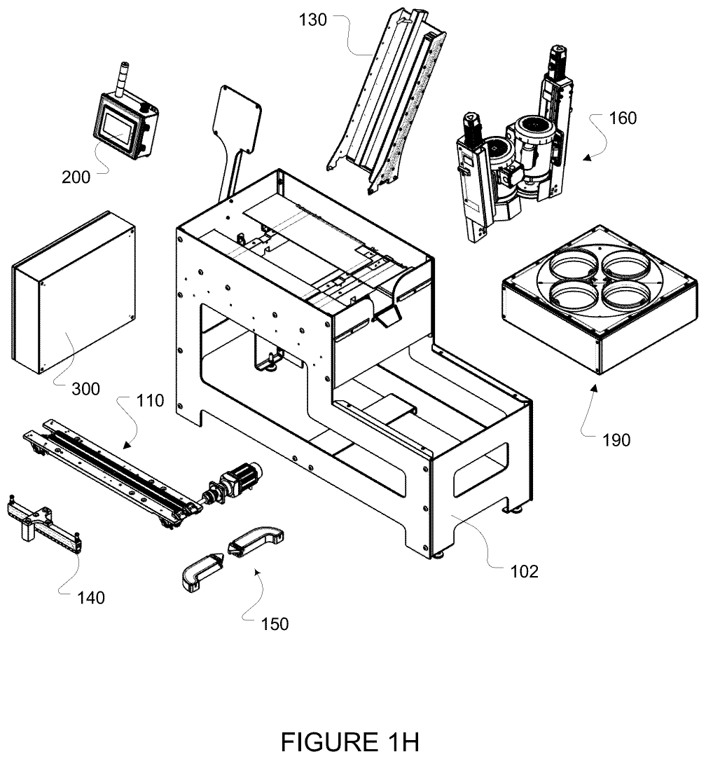

FIGS. 1A-1G illustrate an embodiment of an automatic knife grinder system 100. In this embodiment the knife grinder system is configured to automatically feed, grind, and sort woodworking knives. The knives are illustrated by way of example as chipping knives of a particular length and cross-sectional shape. However, the knife grinder systems (and the corresponding apparatuses and methods) disclosed herein are adaptable for use with industrial woodworking knives of others lengths and shapes, as discussed further below. In addition, features of the knife grinder system 100 and parts thereof that are noted below as optional may be omitted. Therefore, some embodiments of the system or apparatus may lack one or more (or all) of those optional features, and corresponding methods of controlling, operating, or using such embodiments may omit steps or actions that involve the omitted feature(s).

In various embodiments, knife grinder system 100 includes a knife grinder apparatus 100a (for brevity, “knife grinder 100a”) and a control system 100b. Control system 100b is configured to control various operations of knife grinder 100a.

Knife grinder 100a includes a frame 102, a guide track assembly 110, and at least one grinder assembly 160. Preferably guide track assembly 110 and grinder assembly 160 are supported on the frame 102. Mounting both assemblies to a common rigid support with the respective non-moving parts in a fixed spatial relationship may help to reduce errors in the positioning of moving parts, such as the grinding wheel(s) of grinder assembly 160. However, in some embodiments the guide track assembly 110 may be mounted to the frame 102 and the grinder assembly 160 or portions thereof may be mounted to another support structure, or vice versa. In that case, the frame 102 and the other support structure are preferably fixed in position relative to one another.

Referring now to FIG. 2, frame 102 may be configured to support guide track assembly 110. In some embodiments, frame 102 may include upright supports 104, such as legs, beams, plates, and/or other such structures. Frame 102 may also include one or more lateral supports 106, such as beams, plates, sheets of metal or other rigid or semi-rigid materials, and the like. Upright supports 104 and lateral supports 106 may be connected in any suitable manner. Preferably at least one of the lateral supports 106 is connected to two or more of the upright supports 104 to form an elevated base for the guide track assembly 110. For example, as best shown in FIGS. 1H and 2, the upright supports 104 may include legs and/or pieces of sheet metal connected together to form the sides and ends of a generally rectangular hollow body, and the lateral supports 106 may include cross beams and/or plates that connect the sides or the ends of the hollow body. However, the illustrated configuration is not essential. The frame may have any configuration that is suitable to support the guide track assembly in the desired spatial relationship relative to the grinder assembly 160 and/or other components.

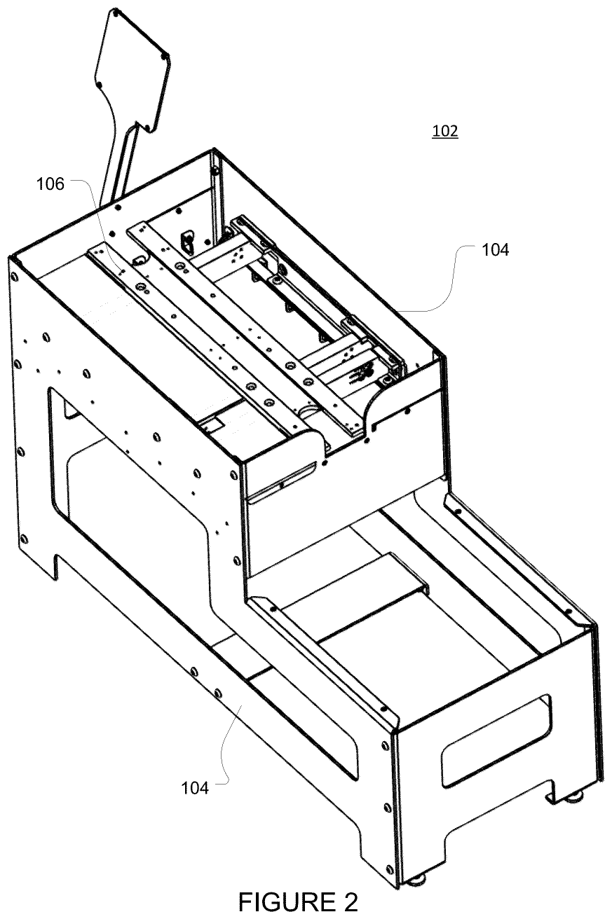

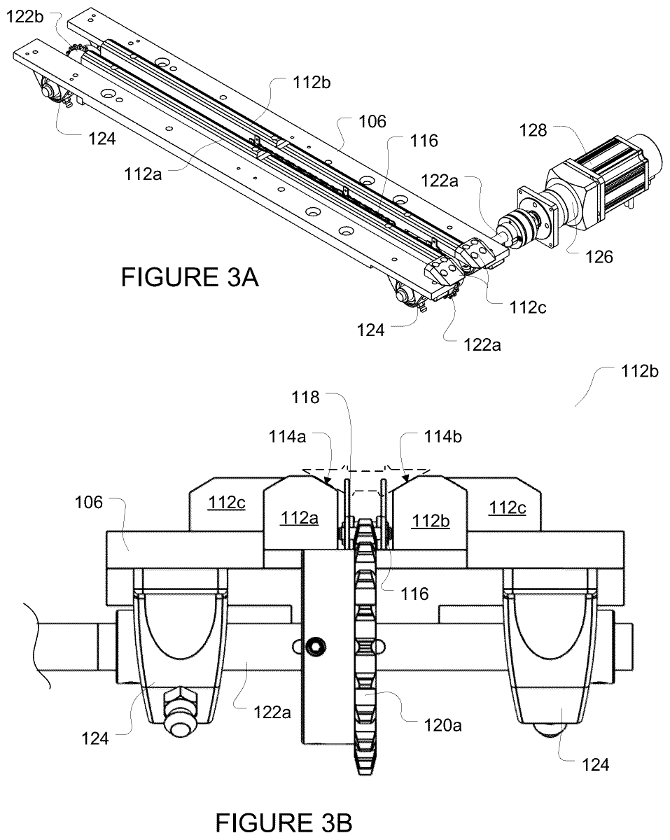

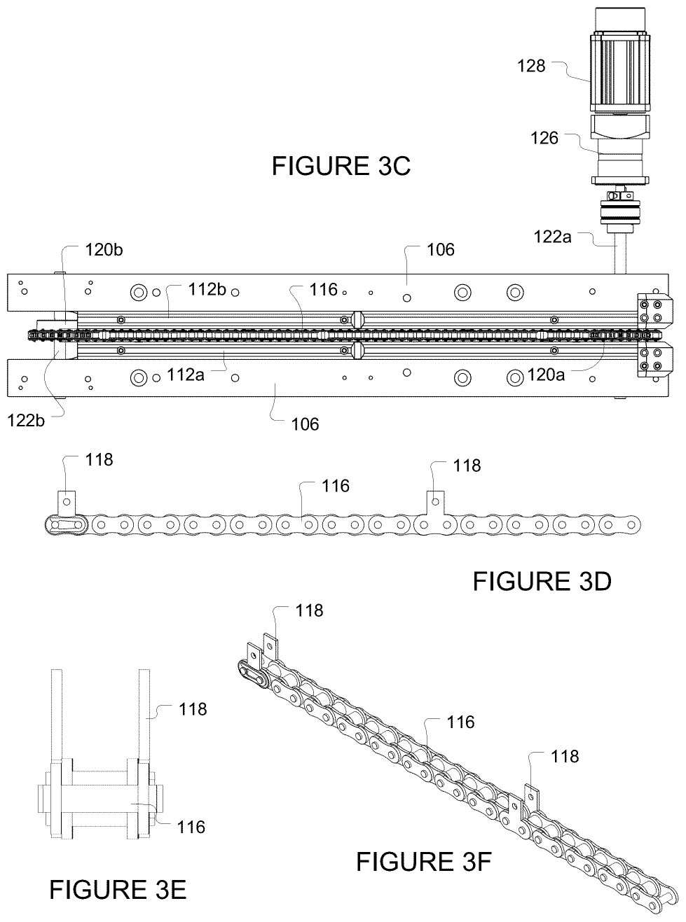

Guide track assembly 110 includes a track 112 and an endless loop 116 (FIGS. 3A-3C). Track 112 may be a pair of rails 112a and 112b, each with a corresponding knife support surface (shown in FIG. 3B as 114a and 114b, respectively). The rails 112a and 112b are parallel to one another and spaced apart by a gap. The knife support surfaces 114a-b collectively define a flow path that extends from an upstream portion of the track 112 to a downstream portion of the track 112. The cross-sectional profile of the rails and/or angle of the knife support surfaces 114a and 114b, and the distance between the rails 112a-b (i.e., the size of the gap between them), are preferably selected to correspond to the shape and dimensions of the knife 10. Optionally guide track assembly 110 and/or frame 102 may further include an outfeed portion that slopes downwardly to direct knives 10 as they exit the guide track 112. If present, the outfeed portion may include a pair of sloped outfeed rails 112c (see e.g., FIG. 3A) and/or a chute 112d (FIGS. 1C, 1D).

Endless loop 116 is preferably mounted to the same support structure (e.g., lateral support(s) 106) as track 112. Endless loop 116 may be a roller chain that engages sprockets 120a and 120b mounted to drive shaft 122a and idler shaft 122b, respectively. Shafts 122a and 122b are mounted to lateral support(s) 106 by respective mounts 124. Mounts 124 may be sealed mounted ball bearings with housings, pillow block bearings, or the like. Drive shaft 122a may be connected to motor 128. Motor 128 can be a servo motor, a stepper motor, or other suitable type of motor. Optionally motor 128 may be connected to drive shaft 128 by a gearbox 126 and/or a flexible shaft coupling. Motor 128 is operable to rotate the drive shaft 122a and sprockets 120a and 12b to drive the endless loop 116 along a rotational path. The upper portion of the rotational path extends between rails 112a, 112b. The lower portion of the rotational path is typically below the track 112.

Endless loop 116 includes at least one lug 118. Lug 118 is dimensioned to extend into the flow path between the rails 112a-b as it is carried along the upper portion of the rotational path of endless loop 116. While endless loop 116 is illustrated as a roller chain, it could alternatively be a belt or the like. In that case, pulleys or sprockets configured to engage the belt may be substituted for sprockets 122a, 122b.

With the knife 10 supported on the rails 112a-b, endless loop 116 may be driven in rotation to bring a lug 118 into contact with the knife to thereby advance the knife along the flow path, on the track 112, in a first direction toward a downstream end of the track.

In some embodiments, endless loop 116 has multiple lugs 118. In that case, the lugs 118 may be spaced apart at regular intervals. The spacing may be selected to correspond to the spatial arrangement of various components/assemblies along the flow path. For example, in embodiments that include a knife receptacle, a sensor assembly, and a grinder assembly (described further below) arranged along the flow path, lugs 118 may be spaced along endless loop 116 such that as one lug is passing through the knife receptacle to engage a first knife, a second lug is advancing a second knife through the sensor assembly, a third lug is moving a third knife through the grinder assembly, and a fourth lug is at or near the distal end of the track to discharge a fourth knife.

In other embodiments the endless loop 116 has only a single lug 118. In particular, some embodiments of the system 100/apparatus 100a include a frame, a guide track assembly, and a grinder assembly, but do not include a sensor assembly and/or a knife receptacle (described further below). In such embodiments the guide track system (and the hold-down assembly, if present) and rotational path of endless loop 116 may be relatively short, reducing the time required for lug 118 to return to the upstream end of the track to engage the next knife. For example, the sensor assembly may be omitted in embodiments that are intended only for use to grind new, unused knives that have substantially uniform dimensions prior to grinding. Such embodiments may be used in the manufacturing of pre-honed knives. Likewise, some embodiments may lack a knife receptacle (e.g., a hopper). The knife receptacle may be omitted, for example, in embodiments configured for use in environments in which knives will be placed onto the track individually by a human operator or by another machine (e.g., a pick-and-place machine, an industrial robot, etc.).

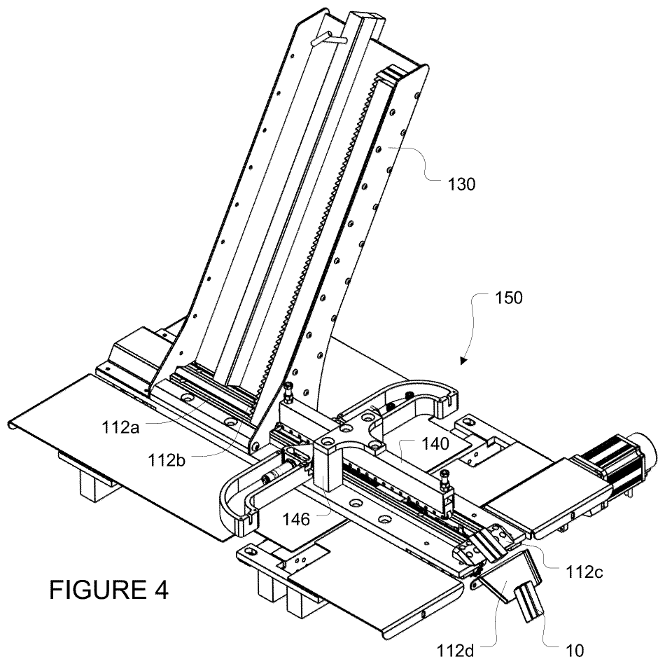

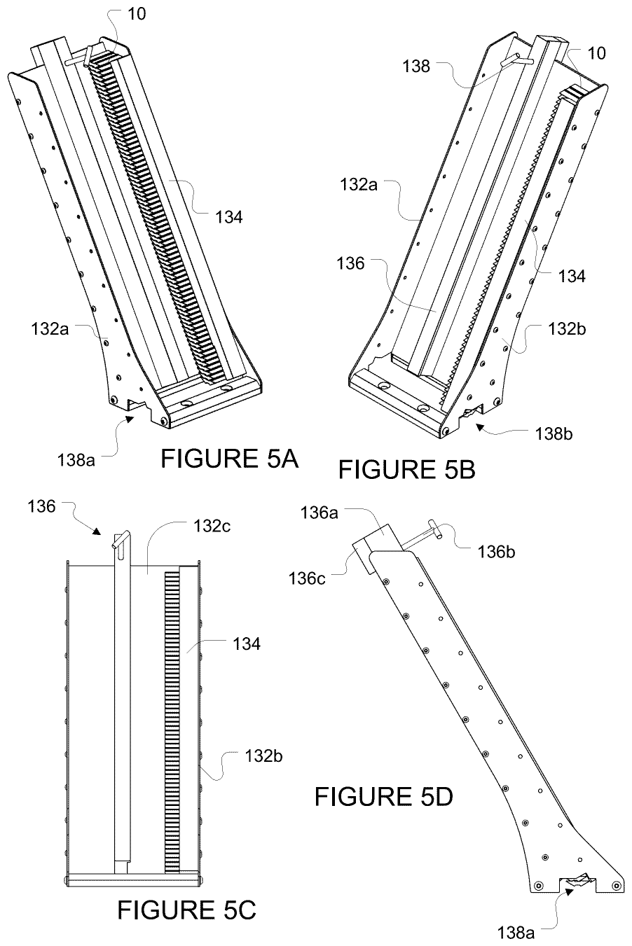

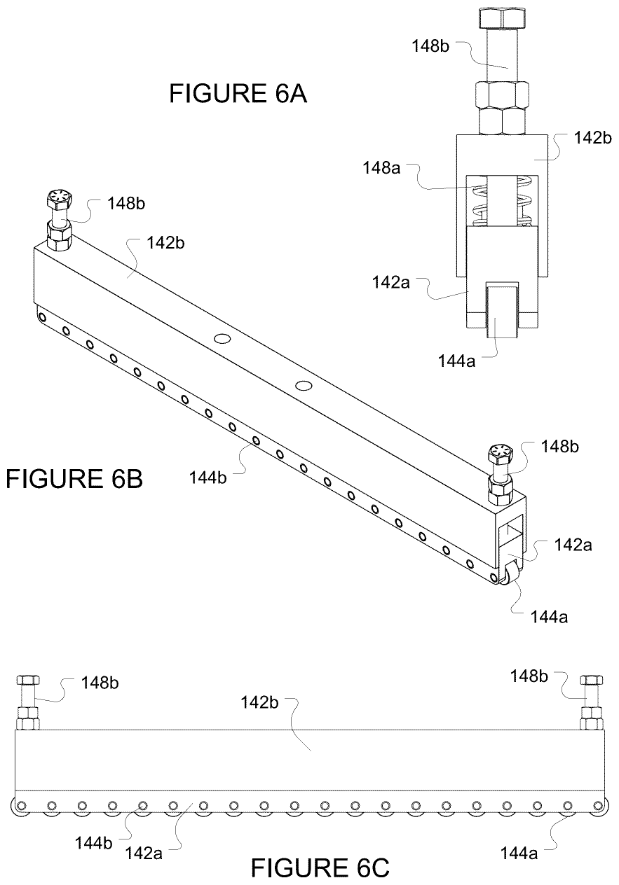

Optionally knife grinder 100a may include a knife receptacle 130 configured to hold one or more knives. Referring now to FIGS. 4 and 5A-5D, knife receptacle 130 is configured to releasably retain a knife 10 on the track 112 at a first location along the flow path. A bottom portion of the knife receptacle 130 defines a passage 138 dimensioned to allow lug 118 and the knife 10 to exit the receptacle along the flow path as lug 118 advances the knife along the track in the first direction. The knife receptacle 130 is located upstream of the grinder assembly 160 (described further below) and/or near an upstream end of the track 112.

In some embodiments, knife receptacle 130 is a hopper configured to releasably retain a stack of knives. For example, in the illustrated embodiment the knife receptacle 130 has a hollow body 132 with opposite sides 132a, 132b connected to corresponding ends of a back 132c. Preferably the back 132c is (or has) an incline of 45-75 degrees relative to horizontal. Each of the sides 132a and 132b has a corresponding slot or contour 138a and 138b, respectively, above the track 112 to allow lugs (and in the case of side 132b, knives) to pass through the sides of the hopper. A stationary guide 134 may be removably or permanently fixed to downstream side 138b. An adjustable guide 136 may be movably mounted to the back 132c. Guides 134 and 136 may be rails or other elongated structures of any suitable shape and size to aid in retaining the knife/knives in the desired position, with the knife or stack of knives disposed between the guides. In the illustrated embodiment adjustable guide 136 includes a guide member 136a (e.g., a rail) that is movably coupled to the back 132c and oriented generally parallel to the sides 132a, 132b. Guide member 136a is coupled at its upper end to a clamp member 136c that engages the opposite side of the back 132c. An adjustment member 136b, such as a threaded T-bolt, is disposed through a corresponding through-hole in guide member 136a. The T-bolt can be turned in one direction to loosen and move the adjustable guide laterally along the back 132c toward or away from the stationary guide 134 and turned in the opposite direction to fix the adjustable guide in place. In operation, a knife or stack of knives is placed into the knife receptacle with the downstream end(s) abutting the stationary guide 134. The adjustable guide 136 is moved into contact with the opposite end(s) of the knife/knives and the T-bolt is turned to fix the adjustable guide 136 in place. This configuration allows the operator to adjust the knife receptacle 130 to accommodate knives of different lengths.

The configuration of the knife receptacle varies among embodiments. Preferably the knife receptacle is adapted to receive a stack of knives such that the bottom-most knife is disposed on the track with the edges to be sharpened facing upwardly. Rotation of the endless loop carries a lug 118 into contact with the upstream end of the knife and advances the lug 118 and the knife along the track 112. As the bottom-most knife is moved out from under the stack, the next bottom-most knife in the stack is deposited by gravity onto the track. While the illustrated knife receptacle 130 is configured as a gravity-fed hopper, in other embodiments the knife receptacle may be an electric hopper or any other device suitable for feeding knives onto the track. Again, some embodiments of the knife grinder assembly do not include a knife receptacle.

In some embodiments, knife grinder 100a includes a hold-down assembly positioned to engage a knife on the flow path between an upstream end and a downstream end of the track 112. In the illustrated embodiment, hold-down assembly 140 includes a series of rollers 144 rotatably mounted to the underside of an elongated lower housing 142a by respective pins 144b. An elongated upper housing 142b is connected to the lower housing 142a by bolts 148b. Bias members 148a (in this example, compression springs) are disposed between the lower housing 142a and upper housing 142b. The hold-down assembly may be mounted to the underside of a support structure 146 that is in turn mounted to the frame (e.g., to a lateral support member 106). Support structure 146 is configured to retain hold-down assembly 140 above the track 112 with the bottoms of rollers 144a extending into the flow path of the knife. As the knife is moved along the track 112, the upper surface of the knife is engaged by the rollers 144a, which are forced upward by the contact to compress bias members 148. As the knife continues to move along the track and rollers 144a roll along its upper surface, the downward force provided by the compressed bias members 148a aids in the retention of the knife on the track.

In some embodiments the upstream end of the hold-down assembly 140 is located near the downstream side 132a of the knife receptacle 130 and the downstream end of the hold-down assembly 140 is located downstream of the grinder assembly. Alternatively, in embodiments that lack a knife receptacle, the upstream end of the hold-down assembly 140 may begin at any location along the track 112 that is upstream of the grinder assembly. In other embodiments, the hold-down assembly may have other configurations. Any device or mechanism suitable to place the appropriate downward force on the knife on the track 112 may be substituted for the illustrated hold-down assembly. Some embodiments may lack a hold-down assembly.

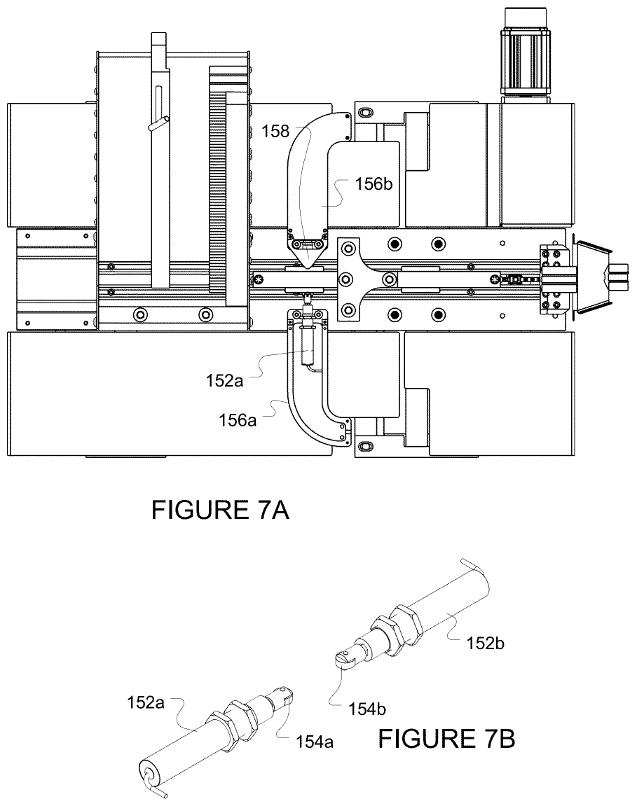

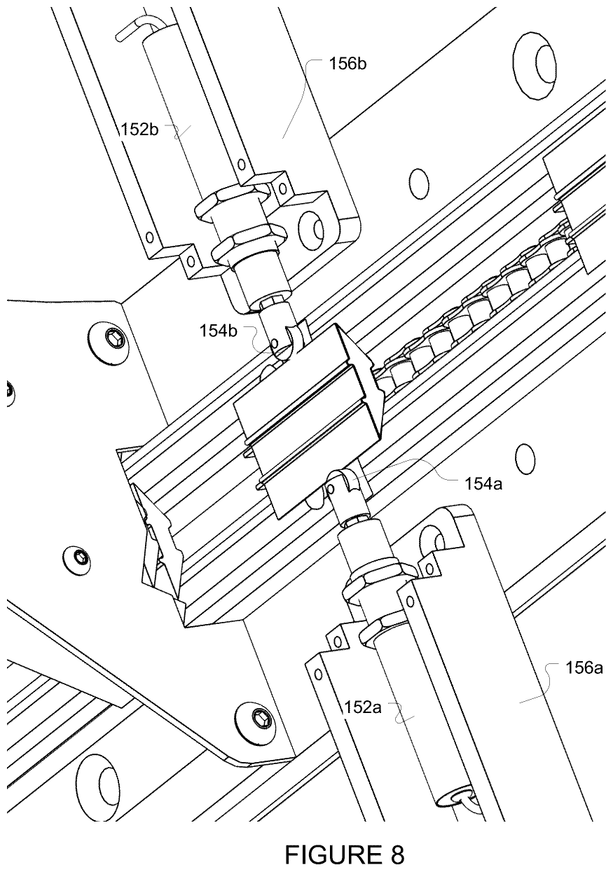

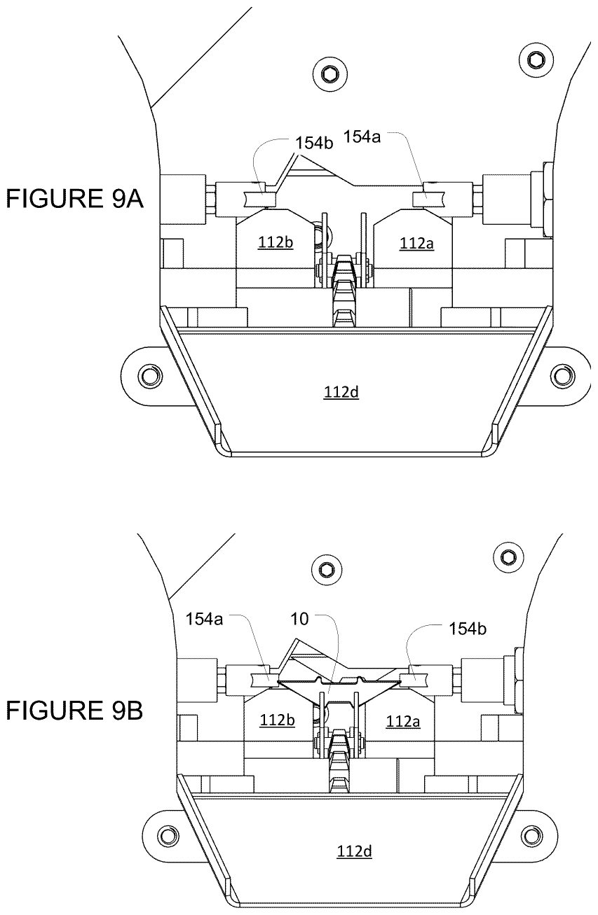

In various embodiments, the knife grinder 100a may include a sensor assembly 150 (FIGS. 7A-9B). Sensor assembly 150 is configured to measure the width of the knife at multiple locations along the length of the knife.

In some embodiments sensor assembly 150 includes sensors 152a and 152b disposed on opposite sides of the track 112. Sensors 152a and 152b are configured to capture measurements of the distance from the centerline of the knife (i.e., the longitudinal centerline of the track 112) to the respective edge of the knife as the knife is moved along the track between the sensors. Preferably sensors 152a and 152b are spring-loaded inductive linear position sensors configured to obtain measurements in response to linear displacement. Each of the sensors is provided with a respective contact roller (154a, 154b) at the distal end of the roller. The sensors are oriented transverse to the track with the contact rollers separated by a gap, the width of which is less than the width of the knife. As the knife advancing along the track 112 enters the gap, the edges of the knife are engaged by the respective contact rollers, which are pushed outwardly away from the centerline of the flow path. This linear displacement of the contact rollers triggers the sensors 152a and 152b to obtain a series of measurements as the contact rollers ride along the respective edges of the knife. Each measurement obtained by a sensor represents the width of the knife from the longitudinal centerline of the knife to the respective edge of the knife at a corresponding location along the length of the knife. Collectively, the measurements collected by sensors 152a and 152b represent the width of the knife at a plurality of locations along the knife. Preferably the sensors 152a and 152b are at least partially contained in respective housings 156a and 156b. Each of the sensors may be provided with a corresponding sensor mount 158, such as a bracket or the like, that is configured to retain a distal end of the respective sensors in the desired position relative to the flow path. In FIG. 7A one sensor mount 158 is shown while the other is hidden to show the underlying features.

The configuration of the sensor assembly varies among embodiments. Other types of sensors that are suitable for measuring the width of the knife may be substituted for sensors 152a and 152b. Alternatively, in some embodiments the sensor assembly may be omitted.

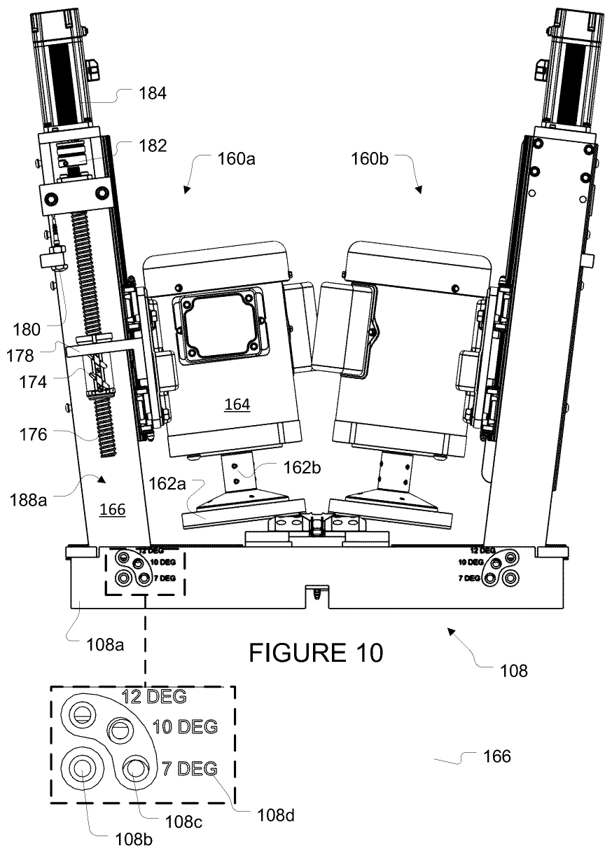

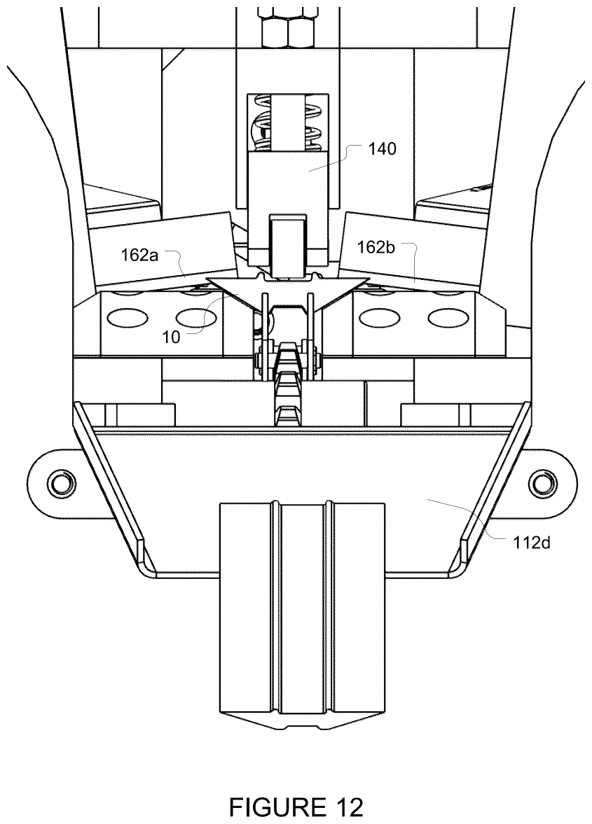

Referring next to FIGS. 10-12, knife grinder 100a may include at least one grinder assembly 160. Preferably the grinder assembly 160 is mounted to the frame 102 and positioned near the downstream end of the track 112. While some embodiments include two grinder assemblies 160a, 160b positioned on opposite sides of the flow path (FIG. 10), other embodiments may have only one grinder assembly 160. For example, embodiments with only one grinder assembly may be designed for use to grind knives with only one cutting edge.

Grinder assembly 160 includes a grinding wheel 162 coupled to a motor 164 operable to drive the grinding wheel 162 in rotation. Preferably motor 164 is movably mounted to a motor support base 166. In some embodiments a guide rail 168 is mounted to motor support base 166 and is movably engaged by one or more carriages 170 (e.g., ball bearing carriages) mounted to motor 164. Motor 164 may be raised and lowered along the guide rail 168 by a linear positioner mounted to motor support base 166 and operatively coupled to motor 164. For example, the linear positioner may include a positioning motor 184 connected to a ball screw 176. The ball screw 176 may be disposed through a corresponding ball nut 174, which is coupled to a bracket 178. Bracket 178 is configured to be connected to motor 164, either directly or via an intermediate coupling member 186, such as a mounting plate/bracket. The upper end of ball screw 176 is connected to a positioning motor 184, optionally via a shaft coupling 182. Positioning motor 184 may be mounted to motor support base 166 in any suitable manner, such as by a motor mount 172 that is fixed in position relative to the motor support base. The positioning motor 184 is configured to rotate the ball screw 176 in opposite directions to move the ball nut 174 up and down the ball screw, thereby raising and lowering the motor 164 and grinding wheel 162.

Motor 184 is preferably a servo motor. Alternatively, motor 184 may be a stepper motor. In that case, motor 184 is preferably coupled with a position sensor (e.g., an encoder). Motor 184 may be connected to the ball screw 176 by a shaft coupling 182 or in any other suitable manner.

In some embodiments grinder assembly 160 may be provided with a position detector 180 configured to detect a home or start position of the screw bracket, ball nut, and/or grinding wheel. For example, in the illustrated embodiment the position detector 180 is a limit switch fixedly coupled to motor support base 166 and positioned to contact the screw bracket 178 when the grinding wheel 162a (or other movable part coupled thereto) is in a “home” or “start” position. In other embodiments, grinder assembly 160 may be provided with other position detection means. In still other embodiments (e.g., those intended for use to grind only new unused knives of uniform width), the position detector may be omitted.

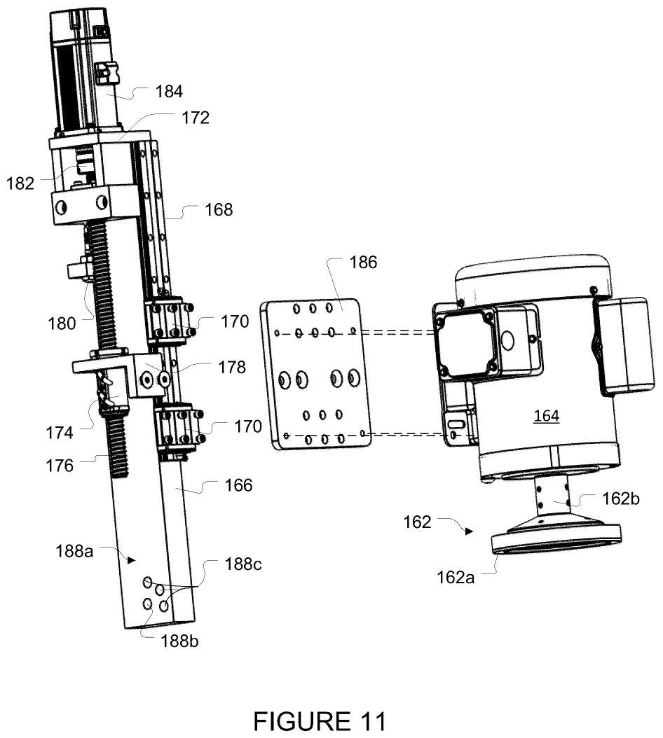

Optionally, frame 102 and/or grinder assembly 160 may include an adjustment guide 108 configured to facilitate adjustment of the angle of motor support base 166. As an example, referring to FIGS. 10 and 11, adjustment guide 108 may be (or include) a support member 108a, such as a plate, beam, or the like, that is fixedly connected to one or more of the upright support members 104 and/or lateral support members 106. Support member 108a extends below, and transverse to, the flow path along a downstream side of the motor support base(s) 166. A pivot through-hole 108b extends through support member 108a in axial alignment with a corresponding pivot through-hole 188b in the downstream side 188a of motor support base 166. A pin, bolt, or other pivot member may be inserted into the through-holes 108b and 188b to secure motor support base 166 to the frame 102 and/or to provide a pivot axis about which the motor support base 166 may be pivoted relative to the support member 108a. Support member 108a may further include adjustment through-holes 108c with corresponding angle indicators (e.g., labels) 108d. In the illustrated example the support member 108a has three adjustment through-holes for adjusting the angle of the motor support base to the corresponding designated angles (7 degrees, 10 degrees, and 12 degrees) relative to vertical, but the number of adjustment through-holes and the corresponding angles may vary among embodiments. The motor support base 166 may be adjusted to one of the designated angles by aligning the corresponding adjustment through-hole 108c with a corresponding adjustment through-hole 188c on the downstream side 188a of the motor support base 166 and inserting a pin, bolt, or other fastener through the aligned through-holes.

Alternatively, knife grinder 100a may be provided with other means for adjusting the angle(s) of the grinder assembly(ies) relative to vertical or relative to the frame. In other embodiments knife grinder 100a lacks a mechanism or means for adjusting the angle(s) of the knife grinder assembly(ies).

Optionally knife grinder 100a may be provided with a sorter assembly 190 disposed downstream of the flow path. Sorter assembly 190 is configured to receive the ground knife in one of a plurality of receptacles.

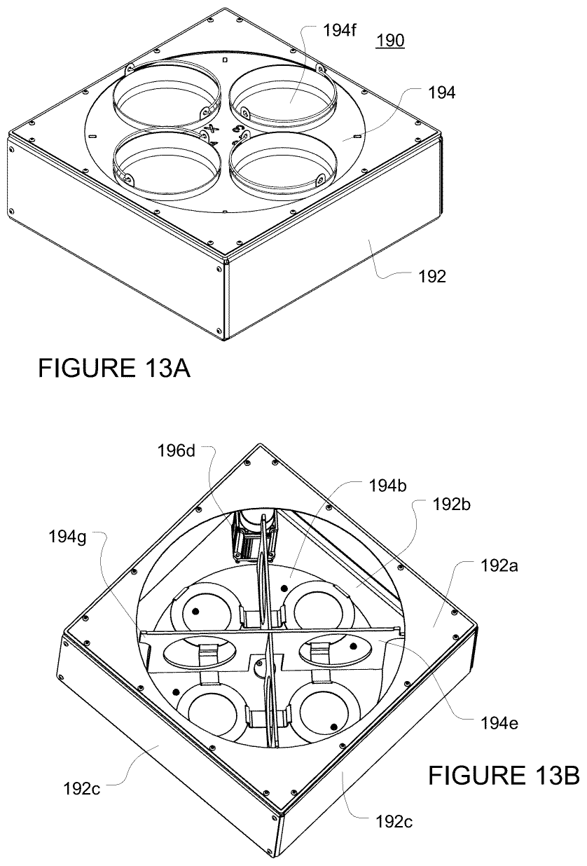

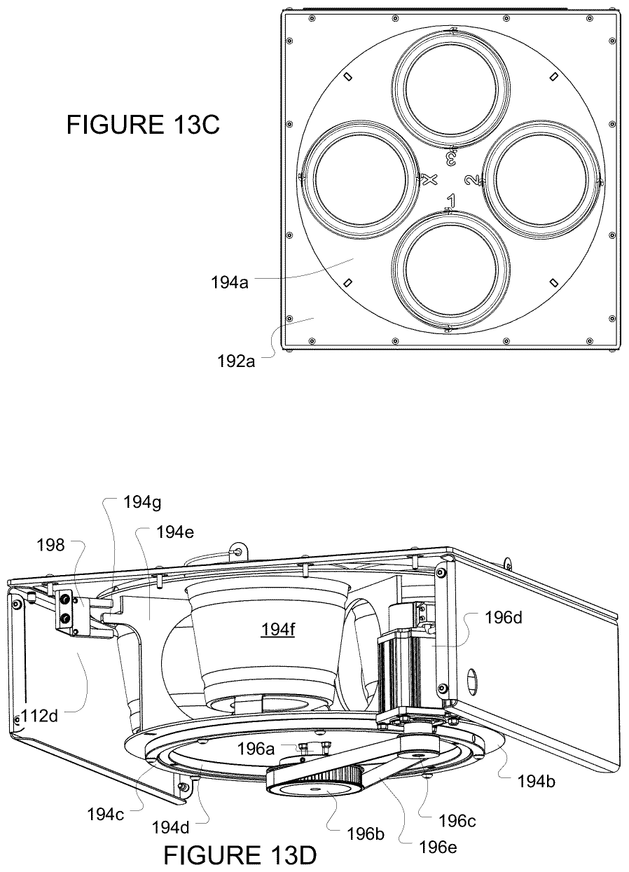

Referring now to FIGS. 13A-13D, in some embodiments sorter assembly 190 includes a stationary frame 192, a rotary frame 194, and a drive system 196. Stationary frame 192 has a top 192a, a bottom 192b, and sides 192c. Top and bottom 192a, 192b are generally rectangular and each has a circular opening. Rotary frame 194 has a top 194a and a bottom 194b joined by internal support ribs 194e. The top and bottom 194a and 194b are circular and slightly larger in diameter than the corresponding openings in the top and bottom 192a and 192b, respectively, of the stationary frame. Internal support ribs 194e between the top and bottom 194a and 194b divide the interior of rotary frame 194 into compartments, each compartment dimensioned to accommodate a corresponding sorter receptacle 194f. Optionally the top 194a may have labels or other indicators to designate the sorting category for each compartment or receptacle 194f. The rotary frame 194 also includes an outer race 194c that is fixedly coupled to the bottom 192b of the stationary frame 192, and an inner race 194d that is fixedly coupled to the bottom 194b of rotary frame 194. The inner race 194d is rotatable relative to outer race 194c, allowing rotary frame 194 to rotate about a vertical center axis relative to the stationary frame 192.

Sorter assembly 190 may have a drive system 196 configured to rotate the rotary frame 194 relative to the stationary frame 192. Drive system 196 may include a shaft 196a fixedly coupled to, and extending from the underside of, the bottom 194b of rotary frame 194. A timing belt pulley 196b is axially mounted on the shaft 196a. A motor 196d is mounted to the stationary frame (e.g., to the bottom 192b), and a second timing belt pulley 196c is axially mounted to the motor 196d (e.g., to the output shaft of the motor). The pulleys 196b and 196c are connected by a timing belt 196e. Optionally, sorter assembly 190 may further include a position detector 198 configured to detect a “home” or “start” position of the rotary frame 194 relative to the stationary frame 192 and/or a location, such as an outfeed end or longitudinal centerline of the track 112 or chute 112d. For example, as shown in FIG. 13D, position detector 198 may be a fork sensor or any other suitable type of through-beam object detecting sensor. In that case, one of the internal support ribs 194e may have an outwardly extending portion 194g, and the position detector 198 may be mounted to the interior of the stationary frame 192 in alignment with the extending portion 194g, such that the “home” or “start” rotational position of the rotary frame 194 is the rotational position at which the extending portion 194g is detected by the position detector 198. If the position detector is a U-shaped fork sensor with the transmitter and the receiver on corresponding ‘arms’ of the fork, the “home” position may be the rotational position at which the extending portion 194g of the support rib 194e is between the transmitter and the receiver.

Motor 196d is preferably a servo motor. However, motor 196d may instead be a stepper motor. In that case, motor 196d is preferably operatively coupled with a position sensor (e.g., an encoder). And while position detector 198 is preferably a fork sensor or other through-beam object detecting sensor, other suitable position sensors known in the art may be used instead. Some embodiments do not include a sorter assembly. For example, some embodiments intended for use to grind only new unused knives with a uniform starting width, or those intended for use to grind knives to a uniform final width, sorter 190 may be omitted.

In various embodiments, knife grinder 100a operates generally as follows. A knife (or a stack of knives) is placed into the knife receptacle 130 as described above; or in embodiments without a knife receptacle, the knife is placed onto the track 112. Motor 128 is operated to drive the endless loop 116 in rotation. Rotation of the endless loop brings lug 118 into contact with the upstream end of the knife. As lug 118 proceeds along the flow path in the first direction, it pushes the knife along the flow path. The knife is engaged by hold-down assembly 140 (if present) as it is advanced along the flow path through the gap between the sensors 152a and 152b (if present) and through the grinder assembly 160 before exiting the track 112 and falling into one of the sorting receptacles of the sorter 190 (if present).

In various embodiments, control system 100b is configured to automatically control at least some of the operations of the grinder apparatus 100a, such as the positions of the grinding wheels relative to the frame and the rotational position of the rotary frame of the sorter assembly.

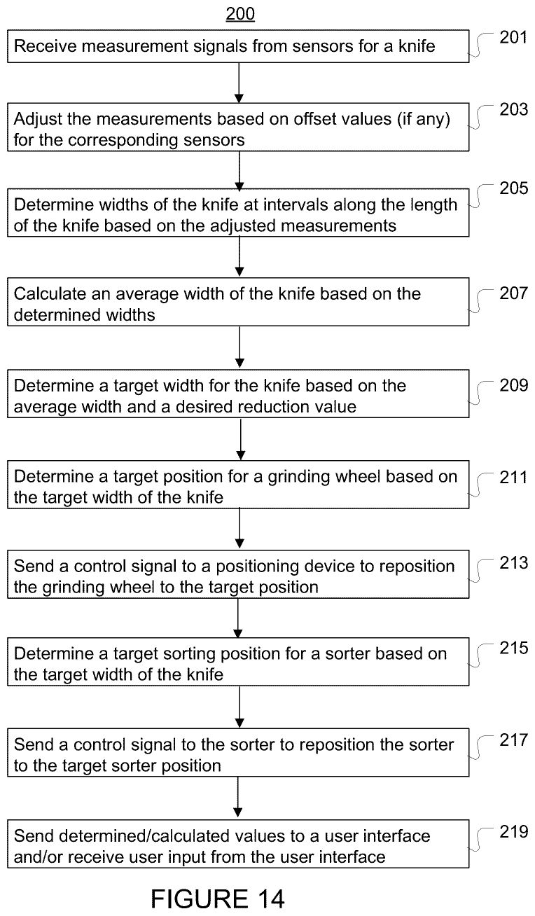

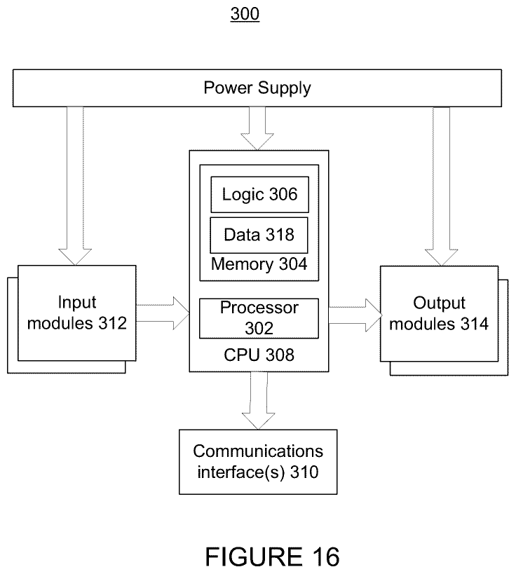

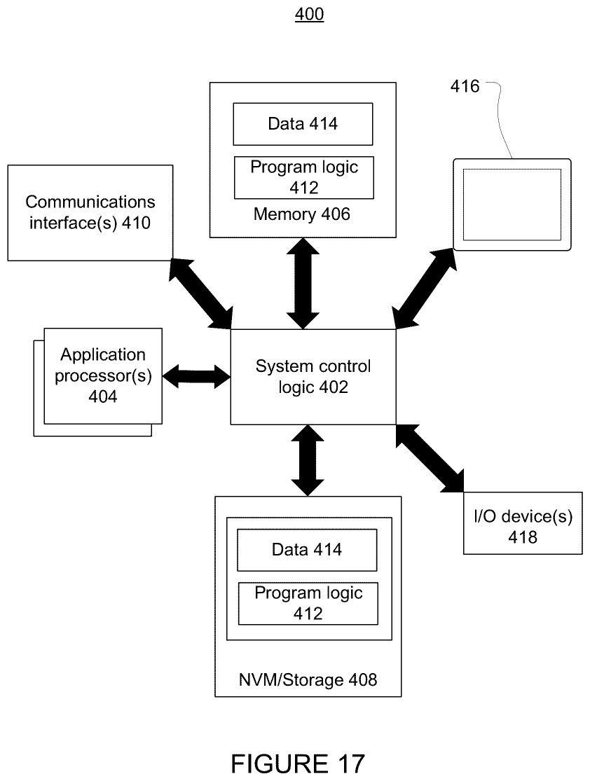

Control system 100b preferably includes a controller 300 (FIG. 16) and a user interface 400 (FIG. 17). In various embodiments, control system 100b is configured to perform some or all of the operations of a method for operating/controlling a knife grinder (e.g., knife grinder 100a). An example of such a method is illustrated in FIG. 14.

Referring now to FIG. 14, at block 201 the controller 300 receives measurement signals from sensors 152a and 152b for a knife (e.g., knife 10) as the knife passes through the gap between the sensors. As the contact rollers at the ends of the sensors roll along the edge of the knife, the sensors send corresponding measurement signals to the PLC. Each measurement represents a measured width of the knife (e.g., the distance from the centerline of the track to the edge of the knife) at a corresponding interval along the length of the knife.

At block 203 the controller 300 adjusts the measurements received from the sensors 152a and 152b based on the offset values (if any) for the sensors. For example, the offset values may be determined through a calibration process and saved to a memory of the controller 300 (or user interface 400), and controller 300 may retrieve those values from the memory. Controller 300 may adjust the measurements received from the sensors 152a, 152b by applying the offset value (if any) for each of the sensors to the measurements obtained by that sensor.

At block 205 the controller 300 determines the width of the knife at intervals along the length of the knife based on the adjusted measurements. If each of the sensors 152a and 152b measures the distance from the centerline of the track/knife to the corresponding edge of the knife, such that each sensor is measuring the width of one side of the knife, the controller may determine a total width at a particular location along the knife by adding the two adjusted measurements (one for each sensor 152a and 152b) for that location.

At block 207 the controller 300 may calculate an average width of the knife based on the widths determined at block 205. For example, the controller may average the total widths to determine an overall average width of the knife.

At block 209 the controller 300 may determine a target width for the knife based on the average width and a desired reduction value. The reduction value may represent the desired reduction in the total width of the knife from edge to edge to be achieved by grinding. For example, a reduction value of 0.002″ represents a reduction of 0.001″ along each edge of the knife. The controller may subtract the predetermined reduction value from the average width of the knife to obtain the target width. Typically the reduction value is entered or selected by a human operator (e.g., via user interface 400).

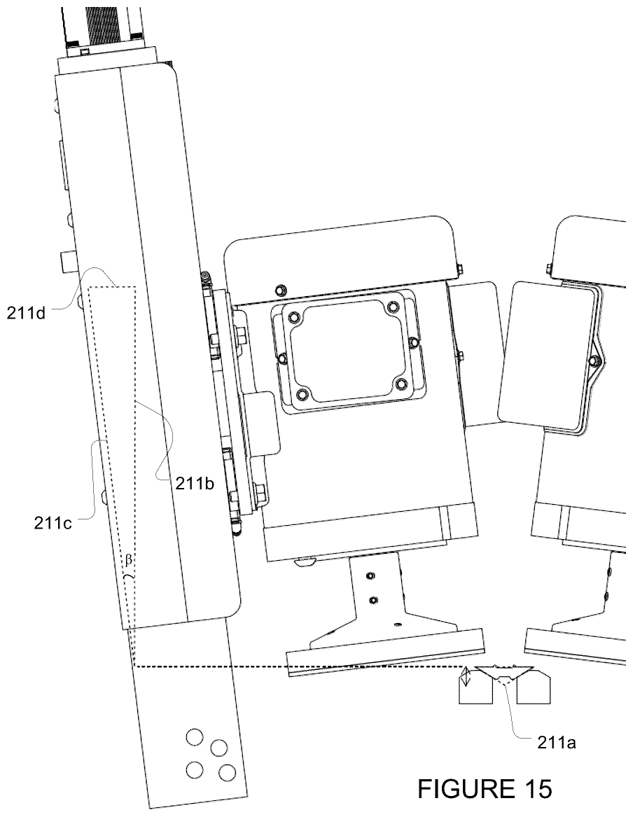

At block 211 the controller 300 may determine a target position(s) for the grinding wheel(s) 162 based on the target width of the knife. For example, the controller 300 may use trigonometric functions to determine the target position(s). FIG. 15 illustrates this principle.

Briefly, the controller may first calculate the height of a triangle indicated at 211a (broken lines around knife 10) based on the measured/target knife width. The angles of the knife support surfaces along the rails 112a and 112b, and the distance between the rails, are known. As such, the bottom point of the triangle is also known. Therefore, the controller may calculate the height of that triangle using trigonometry. Next, the controller may calculate the vertical component (211b) required for the grinding wheel to travel to the necessary vertical elevation for grinding the knife to the target width. This vertical component is one leg of a second triangle, with the second leg (the horizontal leg 211d) representing the “home” position (e.g., the position in which screw bracket 178 engages position detector 180), and the third leg (211c) representing the actual path of travel of the grinder wheel (e.g., parallel to the angle of the motor support base 166 and/or screw 176). The “home” position (defined by the position detector 180) and the angle β are known. As the motor 184 is a servo motor (or a stepper motor provided with a comparable encoder/position detector), the absolute position of the grinder wheel is known and of the grinder wheel 162 is known. Preferably the motor(s) 184 are moved to the “home” position upon startup, and the controller tracks the position relative to the “home” position based on data from the position sensor of the motor 184. The grinder wheel can be repositioned relative to the position detector 180, and the controller can use trigonometry to calculate the required travel distance.

Optionally the controller may determine the target position for the grinder wheel(s) based in part on a determined sorting category for the knife. For example, if the controller determines that the sorting category for the knife is “reject” (i.e., that the knife should not be ground), the controller may determine the target position as the “home” position, such that the knife passes below the grinding wheel(s) without contacting it/them.

Returning now to FIG. 14, at block 213 the controller 300 may send a control signal to the motor 184 of the grinder assembly to implement the determined target position. In embodiments with two grinding assemblies, the controller determines a target position for each of the grinder wheels and sends a control signal to both motors 184 to implement the determined target position for the corresponding grinder wheels.

At block 215 the controller 300 may determine a target sorting position for the sorter (e.g., a target rotational position for rotary frame 194) based on the target width of the knife. For example, if the knife can be sorted into one of multiple categories—e.g., first grind, second grind, third grind, and rejects—the controller may be provided with a predetermined maximum width or range of widths for each category. The predetermined values/ranges may be stored in a memory of the controller and/or input by an operator via the user interface 400. The controller may determine the correct category for the knife by comparing the target width of the knife to the predetermined values/ranges. As with the motor(s) 184, the motor of the sorter assembly (e.g., motor 196d) is preferably sent to a “home” position (e.g., position at which the outwardly extending portion 194g of internal support rib 194e is detected by position detector 198) upon startup of the knife grinder. The position for each sorting category may be set relative to the “home” position—e.g., the position for the first category may be set at 0 degrees, the position for the second category set at 90 degrees, etc. If the sorter motor is a servo motor, or a stepper motor provided with an equivalent encoder/position detector, the motor/controller may track the rotational position of the rotary frame, enabling the controller to determine the rotary position that corresponds to the determined sort category for the knife.

At block 217 the controller 300 may send some or all of the measured/calculated values (e.g., average knife width, target knife width, grinding wheel target position, target sorting position, current grinding wheel position, current sorting position, etc.) to the user interface 400. The controller 300 may also receive user input data and other data from the user interface 400.

FIG. 16 is a schematic illustration of controller 300, in accordance with various embodiments. Controller 300 may be a programmable logic controller (PLC). Alternatively, controller 300 may instead be a personal computer or other computing device. Controller 300 is configured to receive data from, and send data to, user interface 400. Controller 300 is further configured to receive and process data from various sensors/devices of knife grinder 100a, such as sensors 152a and 152b, position detector(s) 180, position detector 198, and/or the encoders/position sensors of motors 184 and 196d.

Referring first to FIG. 16, controller 300 may include a processor 302 and a memory 304 in communication with the processor 302. Optionally, memory 304 and processor 302 may be integrated in a central processing unit (CPU) 308. Controller 300 may also include one or more input modules 312 (e.g., input cards) and one or more output modules 314 (e.g., output cards), and one or more communications interfaces 310. Optionally, controller 300 may also include a power supply 316 configured to convert AC power to DC power. Memory 304 may include volatile memory, non-volatile memory, or both. In some embodiments, memory 304 includes a Random Access Memory (RAM). Optionally, memory 304 may also include Read Only Memory (ROM), firmware, flash memory, a hard disk drive, a solid-state drive, an external storage resource/device, and/or any other suitable type of memory.

Memory 304 includes logic 306 and data 318. Logic 306 includes instructions that are executable by the processor 302 to perform various operations to control the knife grinder 100, such as receiving measurement signals from sensors, adjusting the measurements, determining knife widths, calculating average knife widths, determining target widths for the knives and target positions for the grinding wheel(s) and rotary frame (of the sorter), sending corresponding control signals, and communicating with the user interface 400. For example, in some embodiments the instructions may be executable by the processor 302 to perform some or all of the steps of method 200 (e.g., some or all of blocks 201-219). Data 318 may include user input and other data received from user input 400, as well as data received from sensors, position detectors, motor encoders, and the like.

In operation, feedback/position data from the motors 184 and 196d, sensors 152a and 152b, and position detectors 180 and 198 may be sent through input module(s) 312 to processor 302, which processes the received data according to logic 306. Processor 302 calculates the average and target knife widths and the target positions for the grinder wheel(s) and sorter rotary table, and/or other information (e.g., status of inputs and outputs, additional parameters, etc.) and optionally stores them in memory 304. Command signals from processor 302 are sent through output module(s) 314 to the motors 184 and 196d. Processor 302 sends the determined/calculated values, and optionally other information (e.g., measurement data, current status of motors/actuators, etc.) to operator interface 400, and receives data from operator interface 400, through communications interface(s) 310.

Referring now to FIG. 17, user interface 200 may be a computing device such as a tablet, touch screen PC, laptop computer, desktop computer, or the like. Typically the computing device typically includes system control logic 802 coupled to one or more processor(s) 404 (e.g., a processor core), memory 406/408 coupled to system control logic 402, and one or more communications interface(s) 410 coupled to system control logic 402. Operator interface 400 may also include an interface device 416, such as a display screen or touchscreen, configured to display the user interface. Optionally, operator interface 400 may further include one or more additional input/output (I/O) devices 418 (e.g., a keyboard, mouse, microphone, joystick, or switch, etc.) configured to receive input from a human operator. System control logic 402 may include any suitable interface controller(s) to provide for any suitable interface to at least one of the processor(s) 404 and/or any suitable device or component in communication with system control logic 402. System control logic 402 may also interoperate with input/output device 416 and/or input/output device(s) 418.

System control logic 402 may include one or more memory controller(s) to provide an interface to memory 406. Memory 406 may be used to load and store data and/or instructions. Memory 406 may include any suitable volatile memory, such as RAM and/or dynamic random access memory (“DRAM”). NVM/storage 408 may be used to store data and/or instructions. NVM/storage 408 may include any suitable non-volatile memory, such as flash memory, and/or any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s). In some embodiments, system control logic 402 may include one or more input/output (“I/O”) controller(s) to provide an interface to NVM/storage 808 and communications interface(s) 410.

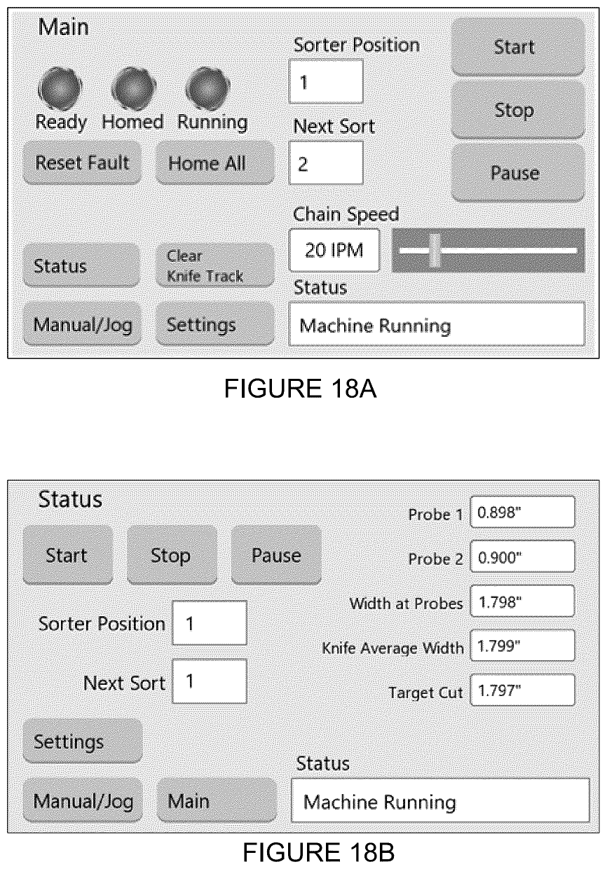

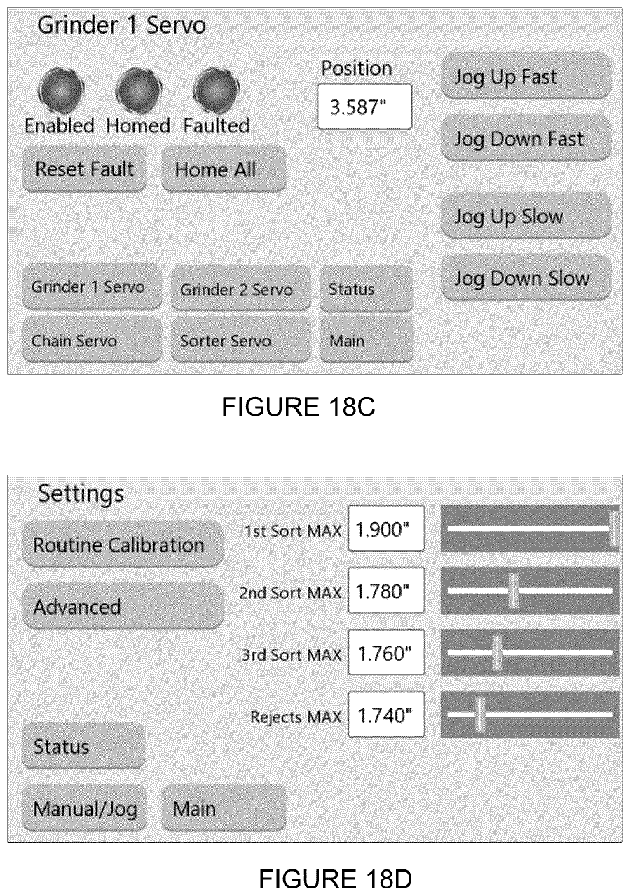

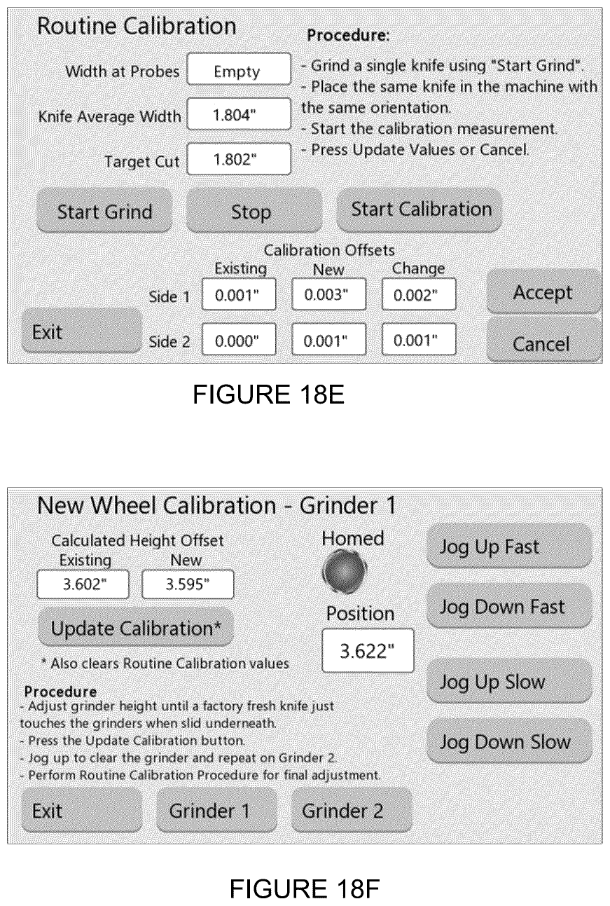

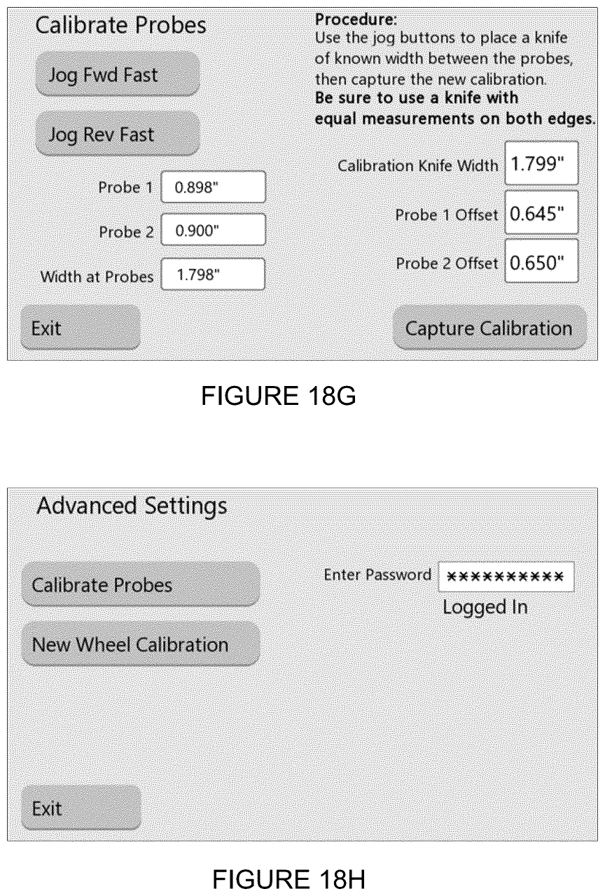

In some embodiments, system memory 406, NVM/storage 408, and/or system control logic 402 may include program logic 412 and/or data 414. Program logic 412 includes instructions that are executable by the processor(s) 404 to perform some or all of the operations of operator interface 400 described herein, such as rendering/displaying a user interface (e.g., a GUI) for a knife grinder system or component(s) thereof, processing operator input (e.g., instructions, operational parameters, set-points, etc.), sending command signals to controller 300, processing data received from controller 300, and updating the user interface and/or memory. An embodiment of a GUI suitable for use with embodiments of the present disclosure is illustrated by way of example in FIGS. 18A-18H.

Communications interface(s) 410 may provide an interface for the operator interface 400 to communicate over one or more network(s) and/or with other devices (e.g., controller 300b, server(s), etc.). Communications interface(s) 410 may include any suitable hardware and/or firmware, such as a network adapter, one or more antennas, a wireless interface, and so forth.

Optionally, NVM/storage 408 may include a storage resource that is accessed over a network via the communications interface(s) 410. Similarly, in some embodiments the computer system includes two or more computer devices and the functions/operations of operator interface 400 are distributed among the computer devices. As an example, the computer system may include one or more servers that perform some or all of the data processing and/or data storage, and a client computer that interacts with the server(s) and presents the user interface on the interface device 416. Optionally, operator interface 400 may be an industrial HMI operator station with an integrated touchscreen.

In summary, in some embodiments a knife grinder system includes a hopper for retaining and gravity feeding woodworking knives onto a guide track system wherein a chain with lugs pulls a released woodworking knife through a grinding assembly, wherein first and second grinding wheels are automatically adjusted by a programmable logic controller and one or more measurement probes, and into a rotary sorting station.

In some embodiments, an automatic machine for feeding, grinding, and sorting a woodworking knife includes one or more of: a hopper for releasably retaining a woodworking knife and having a receiving end and a feeding end, the hopper being gravity fed; a grinding assembly, the grinding assembly having a first grinding wheel and a second grinding wheel; a guide track system for receiving the woodworking knife at a first end and releasing the woodworking knife at a second end, the guide track system comprising a chain with lugs for releasably retaining the woodworking knife and an actuator for moving the woodworking knife received onto the chain with lugs from the first end and the second end, wherein the first end faces the feeding end of the hopper and the second end is positioned distal the feeding end of the hopper, and the guide track system is positioned such that both the first and second grinding wheels are capable of concurrently contacting the woodworking knife as it is moved from the first end to the second end; when the received woodworking knife is moved to the second end of the guide track system, it is released from the chain with lugs; a rotary sorting station, the rotary sorting station positioned to receive and sort the woodworking knife after it is released from the second end of the guide track system; and one or more measurement probes positioned and aligned to take a measurement of the woodworking knife as the woodworking knife is moved along the guide track system between the hopper and the grinding assembly; and a programmable logic controller (PLC).

As used herein, the expression “receiving end” is intended to refer to the end

of the hopper where the woodworking knives are inserted into the hopper. As used herein, the expression “feeding end” is intended to refer to the end of the hopper where the woodworking knives are gravity fed onto the guide track system. By “gravity fed”, it is meant that the woodworking knives retained in the hopper are released by dropping freely from the hopper onto the gravity track system. In some embodiments, the hopper is configured to releasably retain a plurality of woodworking knives. In some embodiments, the hopper is configured to releasably retain one or more woodworking knives. In certain embodiments, the hopper is configured to releasably retain between one and one hundred woodworking knives. In some embodiments, the hopper is configured to releasably retain between about one and fifty woodworking knives.

In some embodiments, the chain with lugs receives a woodworking knife from the hopper by pulling the woodworking knife as it drops into the guide track system. In some embodiments, the actuator comprises a stepper motor, a servo motor, or a combination thereof. In certain embodiments, the actuator comprises a servo motor.

In some embodiments, the measurement of the woodworking knife by the one or more measurement probes comprises measuring the dimensions of the edge of the woodworking knife. By “dimensions of the edge of the woodworking knife”, it is meant to comprise the length, width, and thickness of the edge of the woodworking knife. In some embodiments, the automatic machine comprises two, three, four, five, or six measurement probes. In certain embodiments, the automatic machine comprises two measurement probes. In further embodiments, each of the two measurement probes are positioned on either side of a woodworking knife's edges.

In some embodiments, the PLC determines the woodworking knife's grind status based on the results of the measurement of the one or more measurement probes. In some embodiments, the woodworking knife's grind status is based on specific threshold values of the dimensions of the edge of the woodworking knife. In some embodiments, the woodworking knife's grind status comprises one or more grind statuses. In some embodiments, the woodworking knife's grind status comprises between a first grind and a tenth grind. In certain embodiments, the woodworking knife's grind status comprises a first grind, a second grind, a third grind, or scrap. In some embodiments, the threshold values of the dimensions of the edge of the woodworking knife decrease from the first grind to the second grind to the third grind to the scrap.

In some embodiments, one or both of the first and second grinding wheels are raised or lowered based on the PLC's determination of the woodworking knife's grind status. In some embodiments, the height(s) of one or both of the first and second grinding wheels are adjusted based on the PLC's determination of a third grind such that the measured and determined woodworking knife does not contact the first and second grinding wheels.

In some embodiments, the first and second grinding wheels are positioned to contact the full edge of a woodworking knife. The distance between the first and second grinding wheels are determined beforehand based on a woodworking knife. In some embodiments, the first and second grinding wheels may be adjustably moved to attain a certain distance.

In some embodiments, the rotary sorting station comprises one or more buckets mounted on a rotary bearing, the rotary sorting station rotates to align one of the one or more buckets with the second end of the guide track system, such that the aligned bucket receives a woodworking knife released from the guide track system. In some embodiments, rotation of the one or more buckets comprises actuation by a stepper motor, a servo motor, or a combination thereof. In certain embodiments, rotation of the one or more buckets comprises actuation by a servo motor. In some embodiments, the one or more buckets are each designated for a specific grind status. In some embodiments, the one or more buckets are rotatably positioned, such that a designated bucket receives a woodworking knife based on the woodworking knife's grind status. In some embodiments, the rotary sorting station comprises between one bucket and ten buckets. In certain embodiments, the rotary sorting station comprises four buckets. In further embodiments, the four buckets correspond to a first grind, a second grind, a third grind, and scrap.

In some embodiments, the present disclosure relates to a method for automatically feeding, grinding, and sorting woodworking knives, the method comprising: (a) providing a plurality of woodworking knives to through a receiving end of a hopper; (b) gravity-feeding the woodworking knives through the feeding end of a hopper onto a first end of a guide track system; (c) pulling knives through the guide track system using a chain with lugs; (d) measuring the woodworking knife's grind status using one or more measurement probes; (e) determining the woodworking knife's grind status with a programmable logic controller (PLC); (f) adjusting the height of one or both of a first grinding wheel and a second grinding wheel of a grinding assembly based on the PLC's determination of the woodworking knife's grind status; (g) moving the woodworking knife through the grinding assembly to a second end of the guide track system, thereby grinding the woodworking knife; and (h) receiving the woodworking knife into a designated bucket of a rotary sorting station, thereby sorting the ground woodworking knife.

In some embodiments of the methods disclosed herein, the PLC determines the knife's grind status based on the result of the measurement of the one or more measurement probes. In some embodiments of the methods disclosed herein, the woodworking knife's grind status comprises a first grind, a second grind, a third grind, or scrap. In some embodiments of the methods disclosed herein, one or both of the first and second grinding wheels adjust their height based on the PLC's determination of the woodworking knife's grind status. In some embodiments of the methods disclosed herein, one or both of the first and second grinding wheels adjust their height based on the PLC's determination of a third grind such that the measured and determined woodworking knife does not contact the first and second grinding wheels.

In some embodiments of the methods disclosed herein, the rotary sorting station comprises one or more buckets mounted on a rotary bearing, the rotary sorting station rotates to align one of the one or more buckets with the second end of the guide track system, such that the aligned bucket receives a woodworking knife released from the guide track system. In some embodiments of the methods disclosed herein, rotation of the one or more buckets comprises actuation by a stepper motor, a servo motor, or a combination thereof. In some embodiments of the methods disclosed herein, the one or more buckets are each designated for a specific grind status. In some embodiments of the methods disclosed herein, the one or more buckets are rotatably positioned, such that sorting comprises positioning a designated bucket to receive a woodworking knife based on the woodworking knife's grind status.

In some embodiments of the methods disclosed herein, the steps of determining the woodworking knife's grind status, adjusting the height of the first and second grinding wheels, and sorting the woodworking knife enable efficient maintenance of the woodworking knife based on the woodworking knife's grind status.

Some embodiments of a system for feeding, grinding, and sorting a chipping knife include:
a hopper for releasably retaining a chipping knife and having a receiving end and a feeding end, hopper being gravity fed;
a grinding assembly, the grinding assembly having a first grinding wheel and a second grinding wheel;
a guide track system for receiving the chipping knife at a first end and releasing the chipping knife at a second end, the guide track system comprising a chain with lugs for releasably retaining the chipping knife and an actuator for moving the chipping knife received onto the chain with lugs from the first end and the second end, wherein:
   the first end faces the feeding end of the hopper and the second end is positioned distal the feeding end of the hopper, and
   the guide track system is positioned such that both the first and second grinding wheels are capable of concurrently contacting the chipping knife as it is moved from the first end to the second end;
   when the received chipping knife is moved to the second end of the guide track system, it is released from the chain with lugs;
a rotary sorting station, the rotary sorting station positioned to receive and sort the chipping knife after it is released from the second end of the guide track system; and
one or more measurement probes positioned and aligned to take a measurement of the chipping knife as the chipping knife is moved along the guide track system between the hopper and the grinding assembly; and
a programmable logic controller (PLC).

In this embodiment the hopper may be configured to releasably retain a plurality of woodworking knives. The chain with lugs may receive a woodworking knife from the hopper by pulling the woodworking knife as it drops into the guide track system. The actuator may comprise a servo motor. The measurement of the woodworking knife by the one or more measurement probes may comprise measuring the dimensions of the edge of the woodworking knife. The PLC may determine the woodworking knife's grind status based on the results of the measurement of the one or more measurement probes. The woodworking knife's grind status may be determined based on specific threshold values of the dimensions of the edge of the woodworking knife. The woodworking knife's grind status may comprise a first grind, a second grind, a third grind, or scrap. The height of one or both of the first and second grinding wheels may be adjusted based on the PLC's determination of the woodworking knife's grind status. The height of one or both of the first and second grinding wheels may be adjusted based on the PLC's determination of a third grind such that the measured and determined woodworking knife does not contact the first and second grinding wheels. The first and second grinding wheels may be positioned to contact the full edge of a woodworking knife. The rotary sorting station may comprises one or more buckets mounted on a rotary bearing, and the rotary sorting station may rotate to align one of the one or more buckets with the second end of the guide track system, such that the aligned bucket receives a woodworking knife released from the guide track system. Rotation of the one or more buckets may comprise actuation by a stepper motor, a servo motor, or a combination thereof. The one or more buckets may each be designated for a specific grind status. The one or more buckets may be rotatably positioned, such that a designated bucket receives a woodworking knife based on the woodworking knife's grind status.

In some embodiments a method for automatically feeding, grinding, and sorting woodworking knives includes:
(a) providing a plurality of woodworking knives to through a receiving end of a hopper;
(b) gravity-feeding the woodworking knives through the feeding end of a hopper onto a first end of a guide track system;
(c) pulling knives through the guide track system using a chain with lugs;
(d) measuring the woodworking knife's grind status using one or more measurement probes;
(e) determining the woodworking knife's grind status with a programmable logic controller (PLC);
(f) adjusting the height of one or both of a first grinding wheel and a second grinding wheel of a grinding assembly based on the PLC's determination of the woodworking knife's grind status;
(g) moving the woodworking knife through the grinding assembly to a second end of the guide track system, thereby grinding the woodworking knife; and
(h) receiving the woodworking knife into a designated bucket of a rotary sorting station, thereby sorting the ground woodworking knife.

In this embodiment the PLC may determine the knife's grind status based on the result of the measurement of the one or more measurement probes. The woodworking knife's grind status may comprise a first grind, a second grind, a third grind, or scrap. The height of one or both of the first and second grinding wheels may be adjusted based on the PLC's determination of the woodworking knife's grind status. The height of one or both of the first and second grinding wheels may be adjusted based on the PLC's determination of a third grind such that the measured and determined woodworking knife does not contact the first and second grinding wheels. The rotary sorting station may comprise one or more buckets mounted on a rotary bearing, and the rotary sorting station may rotate to align one of the one or more buckets with the second end of the guide track system, such that the aligned bucket receives a woodworking knife released from the guide track system. Rotation of the one or more buckets may comprise actuation by a stepper motor, a servo motor, or a combination thereof. The one or more buckets may each be designated for a specific grind status. The one or more buckets may be rotatably positioned, such that sorting comprises positioning a designated bucket to receive a woodworking knife based on the woodworking knife's grind status. The steps of determining the woodworking knife's grind status, adjusting the height of the first and second grinding wheels, and sorting the woodworking knife may enable efficient maintenance of the woodworking knife based on the woodworking knife's grind status.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. An apparatus for grinding a knife, wherein the knife is an industrial woodworking knife for power-operated rotary cutter heads, the apparatus comprising:
a frame;
a guide track assembly supported by the frame, wherein the guide track assembly includes a track and an endless loop with at least one lug, wherein the track has a pair of knife support surfaces disposed along opposite sides of the endless loop and configured to support the knife thereon, the support surfaces define a flow path, and the endless loop is rotatable to move the lug in a first direction from a first location along the track to a second location along the track to thereby advance the knife on the track along the flow path from the first location to the second location; and
a grinding assembly having at least a first grinding wheel and a first motor configured to rotate the first grinding wheel, wherein the first grinding wheel is disposed downstream of the receptacle along the flow path.

2. The apparatus of claim 1, wherein the grinding assembly further includes a linear positioner coupled to the motor and selectively operable to adjust the elevation of the first grinding wheel relative to the frame.

3. The apparatus of claim 2, wherein the linear positioner includes a ball screw, a ball nut, and a position detector configured to detect a position of the nut.

4. The apparatus of claim 3, wherein the linear positioner includes a servo motor or a stepper motor connected to the ball screw.

5. The apparatus of claim 2, further including a hold-down assembly mounted to the frame, wherein the hold-down assembly is configured to apply downward force against an upwardly facing surface of the knife on the track.

6. The apparatus of claim 1, further including a sensor assembly configured to detect a width of the knife on the track between the first location and the second location.

7. The apparatus of claim 6, further including a sorter assembly disposed downstream of the track, wherein the sorter assembly includes a rotary frame, a plurality of sorter receptacles, and a drive system selectively operable to rotate the rotary frame to thereby position a selected one of the sorter receptacles to receive the knife.

8. The apparatus of claim 7, wherein the sorter assembly is supported by the frame, and the rotary frame is mounted on a rotary bearing.

9. The apparatus of claim 8, wherein the drive system includes a stepper motor and/or a servo motor.

10. The apparatus of claim 9, wherein the sorter assembly further includes a position sensor operable to detect a rotary position of the rotary frame.

11. The apparatus of claim 1, further including a knife receptacle located upstream of the grinder assembly along the flow path and configured to releasably retain the knife on the track at the first location, wherein the knife receptacle defines a passage dimensioned to allow the lug and the knife to exit the receptacle along the flow path in the first direction.

12. The apparatus of claim 2, further including:
a hold-down assembly mounted to the frame, wherein the hold-down assembly is configured to apply downward force against an upwardly facing surface of the knife on the track;
a knife receptacle located upstream of the grinder assembly along the flow path and configured to releasably retain the knife on the track at the first location, wherein the knife receptacle defines a passage dimensioned to allow the lug and the knife to exit the receptacle along the flow path in the first direction;
a sensor assembly configured to detect a width of the knife on the track between the first location and the second location; and
a sorter assembly disposed downstream of the track, wherein the sorter assembly includes a rotary frame, a plurality of sorter receptacles, and a drive system selectively operable to rotate the rotary frame to thereby position a selected one of the sorter receptacles to receive the knife.

13. A computer-implemented method of controlling the apparatus of claim 12, the method comprising:
determining an average width of the knife based on data received from the sensor assembly;
determining a target width of the knife based on the average width and a desired reduction value;
determine a target position for the grinder wheel based on the target width; and
send a control signal to the linear positioner to reposition the grinder wheel to the target position.

14. The computer-implemented method of claim 13, wherein determining the average width of the knife includes apply an offset value to the data received from the sensor assembly to obtain adjusted measurements.

15. The computer-implemented method of claim 13, wherein the knife grinder further includes a sorter assembly disposed downstream of the track, and the sorter assembly includes a rotary frame, a plurality of sorter receptacles, and a drive system selectively operable to rotate the rotary frame to thereby position a selected one of the sorter receptacles to receive the knife, and the method further includes:
determining a target sorting position for the rotary frame based on the target width of the knife; and
sending a second control signal to the drive system to reposition the rotary frame to the target sorting position.

16. The computer-implemented method of claim 15, wherein each of the sorter receptacles corresponds to a sorting class, and each sorting class is associated with a corresponding maximum knife width or a range of knife widths, and wherein determining the target sorting position includes comparing the average width of the knife or the target width of the knife to the maximum knife widths or the ranges of knife widths.

17. The computer-implemented method of claim 16, wherein one of the sorting classes is a reject/scrap class, and method further includes:
determing, based on the comparison, that the target sorting position is the position associated with the reject/scrap class; and
in response, sending the control signal to the linear positioner to reposition the grinder wheel to the target position, wherein the target position is a position in which the grinder wheel is above the flow path such that the grinder wheel does not contact the knife.

18. A knife grinder system comprising the apparatus of claim 1 and a control system configured to:
determine an average width of the knife based on data received from the sensor assembly;
determine a target width of the knife based on the average width and a desired reduction value;
determine a target position for the grinder wheel based on the target width; and
send a control signal to the linear positioner to reposition the grinder wheel to the target position.

19. A non-transitory computer-readable medium having stored thereon machine-readable instructions that, upon execution by one or more computer processors of a control system, cause the control system to perform the method of claim 13.

20. A computer program product comprising instructions which, when the program is executed by one or more processors of a computer, cause the computer to carry out the method of claim 13.
